(19) United States
(12) Patent Application Publication
(10) Pub. No.: US 2002/0035817 A1
(43) Pub. Date: Mar. 28, 2002

(54) THEMATIC PACKAGING SYSTEM

(76) Inventor: Charles Kormanik Jr., St. Joseph, MI (US)

Correspondence Address: Peter K., Trzyna, P.O. Box 7131, Chicago, IL, 60680, US, (312) 240-0824

(21) Appl. No.: 08/802,472

(22) Filed: Feb. 18, 1997

Related U.S. Application Data
(63) Continuation-in-part of application No. 08/339,602, filed on Nov. 15, 1994, now Pat. No. 5,695,055.

(51) Int. Cl. B31B 1/26

(52) U.S. Cl. 53/441

(57) ABSTRACT

### Abstract of Disclosure

A method for making a protective sleeve comprising a combination of a mouth and a sleeve, the combination comprising a sleeve having a first and second flaps extending beyond the sleeve, each flap having a proximate side and a distal side, with the sleeve having an opening between the flaps and having a protective mouth. The mouth includes a lip formed by folding the first clap along a line and away from the opening until the first flap is adjacent to the sleeve; a second lip formed by folding the second flap over the opening until the second flap is adjacent to the first lip; and including joints adjacent to the proximate and distal sides of the second flap, the joints being located to urge the flaps in an orientation planar with the sleeve. The protective sleeve can be incorporated in rain apparel, in thematically-shaped packaging, which in turn can be in thematically-configured packaging, with the packaging having multipurpose functionality.

### Cross Reference to Related Applications

The present application is a continuation-in-part patent application that claims priority from U.S. Patent Application Ser. No. 08/339,602 filed November 15, 1994.

### Background of Invention

The present invention pertains to a method for making and using packaging, as well as the packaging produced thereby. The packaging can be for a protective covering or another article. More particularly, the preferred packaging is shaped or structured to suggest a use of an article within; the packaging can have several intended uses, as in sequential uses. Additionally, the packaging can be structured for attaching and then detaching the packaging to another article used as suggested by the structure of the packaging.

In the past, packaging has mainly been used for one purpose - packaging! Sometimes packaging has been shaped to correspond to the contents, such as occurs in the case of stretch wrapping, vacuum-formed packaging, and the like. Here, the shaping of the packaging is for convenience in manufacturing the packaging. In the situation of a generically shaped container, for example, an aerosol can, the shape of the container does not communicate the contents or an activity in which the contents are to be employed. That is, if it were not for a label on the aerosol can, one would not know whether the can contained PAM cooking oil, or paint or insecticide. The three dimensional structure of the container does not communicate much more than an implication that whatever the contents might be or how they might be used, they can be at least be dispensed by the aerosol can). Moreover, such amorphous-shaped packaging seems to generally contemplate that the container is discarded or recycled, rather than used in connection with some subsequent activity. With regard to contents for containers, previous articles such as protective coverings for receptacles, particularly those involving golf bags, have been proposed. Representative examples are shown in U.S. Patent Nos. 3,709,553 (Golf Car Rain Coat); 3,754,587 (Golf Club Cover); 4,752,004 (Protective Cover for Gold Bag); 4,953,768 (Golf Bag Rain Cover); 4,200,133 (Golf Bag Cover); 4,979,548 (Golf Bag Cover); 5,005,624 (Device for Protecting Golf Clubs); 5,058,642 (Golf Bag Cover); 5,131,442 (Golf Bag Cover for Protecting Clubs); and 5,220,950 (Golf Bag Cover). Protective covers can also include sandwich bags, seat cushion covers, rain gear, shirt packages, and the like. The variety of designs for protective covers or receptacles reflects the variety of uses. Some protective covers that are closed by means of a mouth having a flap (e.g., that in U.S. Patent No. 3,754,587). However, this type of mouth tends to open to provide a poor seal when the receptacle is flexed, unless a seam or other closing approach is used. Further, the known prior art receptacles that have specific uses, such as that for protecting golf bags from inclement weather, have devoted little attention to packaging for the receptacles.

### Summary of Invention

It has been discovered that packaging can and should have independent utility from merely containing. The shape of the packaging can be useful, for example, in communicating what is in the packaging and/or how to use the contents of the packaging. For a more specific example, packaging shaped like a golf ball suggests that the content of the packaging is useful in connection with the game of golf, e.g., light weight rain apparel or gear packaged in the golf ball for use in playing golf in the rain. Consider another embodiment of a structural indicia approach for configuring packaging-replica of a wheel for a racing car, the replica being an openable packaging for a poncho for use in watching an automobile race in the rain. Indeed, the poncho itself could be shaped like a wheel, further forming correspondence between the container and its content.

The process for making structural indicia packaging can therefore be described as having the steps of selecting a symbol or icon having a shape that suggests an activity (such as selecting a golf ball to suggest playing golf); constructing a replica of the symbol or icon, the replica having a hollow within an exterior to form packaging for an article (such as construction a plastic replica of a golf ball having a hollow within a capsule-like exterior so that the replica golf ball can package an article); and locating the article within the packaging, the article being an article that is useful in connection with the activity suggested by the shape of the packaging (such as locating rain gear in the replica of the golf ball to play golf in the rain). Accordingly, there is formed a combination of packaging structured to suggest use of an article contained therein, such as a light poncho for use in playing golf in the rain. Moreover, the packaging can itself be within suggestively shaped packaging - such as the typical box for golf balls.

Further, the packaging can have multiple purposes. In the example of the golf ball-shaped packaging, after removal of the rain dear, a golfer's pocket change would be located within the ball for convenient storage while playing.

Indeed, the golf ball-shaped packaging could further have a small ring set therein so that the ball could be attached to a strap, ring, or loop on the golf bag. Thus, an otherwise loose ball container can be more conveniently located by securing the golf ball-shaped packaging to a loop, ring, or other fixture of the golf bag. Alternatively, the ring could attach to a divot repair tool or the like, which might itself carry a logo of the golf course.

A further stage of use for the golf ball-shaped packing be made of a substance that one could write upon, so that the golf ball packaging could serve as a tag on the bag. Still another use might be to have the golf ball packaging communicate a golf-related message, for example by including the logo of the golf course imprinted on the golf ball packaging.

Accordingly, the product of present invention would extend to such as golf ball-shaped packaging of (e.g.) rain gear; the packaging shape implying an independent subsequent use n connection with golf (e.g.) to contain pocket change while the golfer is playing the game; the packaging of the golf ball-shaped packaging implying other items useful in connection with golf (e.g.) insect repellent, bee sting treatment, etc.; the golf ball-shaped packaging suggesting still another use in connection with golf (e.g.) as a golf bag tag; the golf ball-shaped packaging communicating still additional information (e.g.) the logo of the golf course. Any and all of such permutations come from the method for shaping the packaging to suggest a use of the contents.

With further regard to the rain gear within the golf ball-shaped packaging, the rain gear can include a protective covering which can be a plastic sleeve or bag, a version of which is suitable for keeping precipitation form wetting golf clubs and other implements of the game that are stored in a golf bag.

Such rain gear can involve a receptacle made with two flaps provides a better closure for the mouth of the receptacle than that generally obtained from one flap, and thus protective coverings and packaging therefore can make use of this improvement.

For example, a protective sleeve can be made from a tube or by means such as two rectangular plastic sheets placed in parallel orientation and seamed along opposing edges to form sides. When desirable for a particular use, the protective sleeve can have a bottom formed by a seam joining another edge of each sheet. Between the sides of this sleeve, there is a top. A portion of the top can be folded over a line perpendicular to the sides to form a flap comprised of lips from both sheets. The flap has two ends, a proximate and a distal end, and a joint located adjacent to each of the ends and one of the sheets disposes the flap and the sheets in a parallel orientation. Preferably, a tab-like seal spaced inward from each of the ends aids in disposing the flap and sheets.

In an embodiment of the present invention, a second fold is located in the top portion of the sleeve. The fold can be in the same direction as the first fold, or the second fold can be in the opposite direction. In either case, the second fold can be in the midst of the clap, or alternatively, the second fold can be located in the sleeve so that the flap is unbroken by the second fold.

In using the mouth with a flap having two lips, after the mouth has opened to locate an item in or out of the sleeve by pulling the lips apart, the ends or the tabs of the flap can be pilled outward to close the sleeve. The mouth with a flap having two lips is better disposed to closure such that during flexing of the sleeve, both lips comprised in the flap tend to flex harmoniously, providing a better protection against undesired opening of the mouth than might occur from a flap made from a single lip. Tabs 31 and 33, useful for improving the ease of handling during closing of the flaps, may be formed at each of the proximate and distal ends 24 and 26 of the flap 20 by creating a respective seam or area spaced from each of the ends 24 and 26 and running approximately the length of the flap 20. The seams, which preferably fasten all sheets of the flap, may be welded, heat sealed, or otherwise joined.

Further, addition of the tabs allows easy location of the proximal and distal ends of the flap and ensure proper orientation of the sheets of the flap to allow the flap to snap shut when the tabs are pulled in opposite directions.

Additionally, a protective sleeve such as that employing the protective cover can be packaged thematically. For example, if the sleeve is used for a golf bag, this sleeve can be housed in a plastic assembly resembling a golf ball, which in turn can be located in a box resembling that which is used to house golf balls, thereby suggesting the use to which the sleeve can be applied. Alternatively, the sleeve could be used to hold materials as with a "ditty" bag.

Finally, the present invention with thematic packing can be utilized in a variety of contexts, for example, where such rain gear is useful, with the packaging resembling the balls or other accouterments of each context, along with a box therefore. Potential applicants can include plastic ball housings and respective boxes for gear suitable for baseball, football, and tennis games, other outdoor events such as concerts or shows, or other activities.

### Brief Description of Drawings

FIGURE 1 is a drawing of a first embodiment of a protective sleeve comprising a mouth in combination with a sleeve according to the present invention;FIGURE 2 is a drawing of a second embodiment of a protective sleeve comprising a mouth in combination with a sleeve of the present invention;FIGURE 3 is a drawing of the protective sleeve of the present invention being used to cover a golf clubs within a golf bag;FIGURE 4 is a drawing of golf ball-like packaging for the protective sleeve of the present invention; andFIGURE 5 is a drawing of a box containing the golf ball-like packaging for the protective sleeve of the present invention.

FIGURE 6 is a representation of a ball and ring embodiment.

### Detailed Description

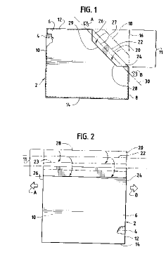

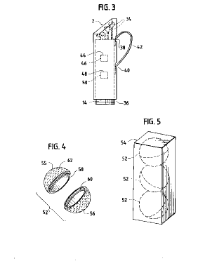

FIGURE 1 illustrates one embodiment of a protective sleeve 2 in accordance with the present invention. Protective sleeve 2 can be made from two adjacent sheets 4 and of plastic. The sheets can be joined by seems 8 and 10 to define respective sides of the sleeve. In contradistinction to FIGRE 2, FIGURE 1 shows a mouth 11 located at a corner of the sleeve, such that seam 12 extends from seam 10 a portion of the way toward seam 8. The seams can be welded, heat sealed, or otherwise joined. Instead of a seam, some other means for joining the sheets would work just as well, as would a seamless sleeve or tube formed by extrusion, for example. A bottom 14 of the protective sleeve 2 can be defined by locating a seam 14 along edges of the sheets 4 and 6 between seams 8 and 10.

In this first embodiment, if the sleeve is being formed from the two adjacent sheets 4 and 6, a corner 16 (denoted in FIGURE 1 with dashed lines) of each of the sheets 4 and 6 can be removed. Preferably, to form the mouth 11 both the corners are removed up to an edge line 18, though the sheets 4 and 6 need not have equal areas removed. A flap 20 comprised of a portion of each of the two sheets 4 and 5, is relocated by rotation along fold line 22. Flap 20 is then joined to the sheet 4 and/or 6 at a proximate end 24 of the flap and a distal end 26 of the flap.

Accordingly, flap 20 has two lips, lip 27 and lip 29, emanating from sheets 6 and 4, respectively. There also is an opening 28 to the protective sleeve 2 through the mouth 11. Tabs 31 and 26, shown as a triangular area in FIGURE 1 and as a line or edge in FIGURE 2.

In using a protective sleeve 2 made as described above, mouth 11 and opening 28 can be used to insert or remove an implement from the protective sleeve 2. This can be accomplished by moving the lips 27 and 29 apart to expand the area of the opening 28. Then, by pulling opposing ends or tabs 24 and 26 outwardly (as illustrated by arrows A and B in FIG. 1), the opening 28 is drawn closed. To further induce the closing, the protective sleeve 2 can have a crease set along fold line 22 by heat or mechanical means. To induce closing over more, a second fold can be located along a line 30 in flap 20 (or in the protective sleeve 2, as shown in FIG. 2). The second fold can be in either direction rotating along line 30, with joints located adjacent ends 24 and 26 to bias sheets 4 and 6 into the second fold.

FIGURE 2 illustrates another embodiment of the protective sleeve 2 of the present invention. Again there are two adjacent sheets 4 and 6, oriented and combined generally as set forth above, except that the opening is not formed from a corner. Also, for better closure, a double fold is illustrated.

More particularly, flap 20 is formed by folding sheets 4 and 6 along line 22, either direction, as shown in FIG. 2. Optionally, a second fold in either direction along line 23 locates the second fold in the protective sleeve 2 while leaving flap 20 unbroken, as illustrated in FIG. 2. That is, flap 20 is drawn over or under flap line 23 and adjacent to sheet 4 or sheet 6; the proximate and distal sides 24 and 26 are suitable locations for joining the flap 20 to the respective sheet 4 or 6.

The use of the second embodiment of protective sleeve 2 is much the same as that described above. After inserting or removing an implement from the protective sleeve 2 via mouth 11 and opening 28, the opposing ends 24 and 26 are pulled apart in directions denoted by arrows A and B to close the protective sleeve 2. Similarly, tabs 31 and 33 can instead be pulled apart.

FIGURE 3 illustrates one of the many applications for this invention; the application is as a protective sleeve for golf clubs 34 in a golf bag 36. The protective sleeve 2 is made of a length sufficient to extend over the golf clubs 34 and preferably over a portion of the golf bag 36. The opening 28 is of sufficient size and at a suitable location so as to permit removal and replacement of the golf clubs 34 in the golf bag 36. The flap 20 limits precipitation from entering the opening 28.

Preferably for this application, the protective sleeve has two additional openings 28 and 40 along its vertical axis. The additional openings 38 and 40 are of sufficient size and spaced sufficiently apart to allow a carrying handle 42 to be connected to the golf bag 36 through the additional openings 38 and 40. Bottom 14 can be left unseamed to permit the golf bag 36 to sit directly on ground.

Note that for protection against inclement weather and other conditions where moisture is a factor, the protective sleeve 2 should be made of water resistant or water proof material, such as plastic, rubber, or the like. Cloth could function as a water resistant material, but its weight for most applications is excessive.

As a further feature for applying the present invention to protect golf clubs 34 in a golf bag 36 from inclement weather, there can be one area 44 of perforations in the protective sleeve 2. The perforations are located along a portion of a circumference of the protective sleeve 2, the perforations 44 being sufficient in number and located to permit tearing the protective sleeve 2 along the perforations for accessing a pocket 46 in the golf bag 36.

Similarly, a second area of perforations 48 in the protective sleeve 2 can be located along a portion of another circumference of the second area of the sleeve 2, the seconf area of the perforations 44 being sufficient in number and located to permit tearing the protective sleeve 2 along the second area of the perforations 48 for accessing a second pocket 50 in the golf bag 36.

In such an application, the protective sleeve 2 can be located in thematic packaging. For example, an embodiment of the present invention can be located in the thematic packaging 52 that resembles a golf ball. Although the packaging 52 could be made by stuffing the protective sleeve 2 into a balloon, latex sleeve, or the like,, having printing that depicts the exterior of a golf ball, a more realistic looking version can be made from two generally hemispheric halves 54 and 56, joinable by such means as an interior lip 58 that engages an exterior lip 60 when the halves are pushed together to encase the protective sleeve 2. For an even more realistic appearance, the packaging 52 can have marks 62, identical to the dimples on a golf ball. However, for adapting the golf ball to receive writing from a pen, magic marker, or the like, a smooth surface is preferable.

To continue the theme, three of the packaging 52 items can be located in a box 54 resembling that which is used to contain and sell golf balls -- or more precisely, what is known as a "sleeve" of golf balls. In a similar vein, the items in the box 54 can include a variety of articles made of the protective sleeve 2, including a rain coat or vest, a hat, a wiping cloth, or a seat cover for a golf cart seat. This permits a set of golf-related protective coverings for inclement weather to be packaged in a manner suggestive of their use.

The box 54 can be stored in one of the two golf bag pockets 46 and 50, as can a similar looking box containing real golf balls.

The method for making the thematic packaging can commence by selecting a symbol or icon suggestive of an activity. More amorphous shapes such as cylindrical can or cubical box will not suffice because the generic shape would communicate no information concerning the content of a container having the shape and/or how the content should be used. Instead, the shape should be selected to be informative or suggestive. What is important is to pick a symbol or icon suitable for thematically-shaped packaging for a subsequently used article.

Consider the following examples (to supplement the golf ball example previously described). The Disney Epcott Center is a well known structure. Mickey Mouse is a well known icon. A hockey puck is also a suggestive shape due to its dimensions, which are distinct from those of a generic tin can. A chess piece, a life preserver, The King - Elvis Presley, a coke bottle, etc. all are known three dimensional shapes that can be used to convey information, and thus all these can be used for thematically-shaped packaging.

Similarly thematically-shaped packaging can be utilized to market items like the protective sleeve 2 in a variety of areas. These include rain gear housed in packaging shaped like baseballs, footballs, tennis balls, etc. for use at such sporting events and these can be placed in boxes 54 suggestive of real balls used for these sports.

Another step in the process is to form a combination of the thematically-shaped packaging (i.e., a replica of the symbol or icon) and, located therein, an item or article having a use suggested by the thematically shaped packaging. The article preferably has a three dimensional shape different from that of the packaging, and the size of the packaging need not be the same as the symbol or icon. That is, the golf ball-shaped packaging need not be golf ball-sized packaging, and a larger replica could be useful for holding larger items, such as a poncho, 10 tees or so, 3 ball marks or so, Band-Aids, or other larger items or combinations of items. As another example, consider a three dimensional VISA, MASTERCARD, DINER'S CLUB, AMERICAN EXPRESS, or similar card, configured into three dimensional packaging being suggestive of use in keeping a charge or banking card, and later, receipts from using the card, etc.

This process is intended to be particularly suitable for packaging an article that is marketed in the combination. For example, a gas can is not normally marketed filled with gasoline, although the shape of the can together with the traditional spigot extending from the can is suggestive of using the gasoline. By contrast, marketing rain apparel in an Epcott Center-shaped package or in a Mickey-Mouse-shaped package suggests use of the rain apparel during a visit to Disneyland.

Another step in the process involving thematically-shaped packaging for a subsequently used item is, indeed, to remove the item or article from the packaging and use the item or article in a use suggested by the shape of the packaging. Also, the packaging itself may be used, preferably in a use also suggested by the shape of the packaging. For example, the above-referenced golf ball-shaped packaging can (after removal of the rain gear, sun screen, or the like) be used to keep the golfer's pocket change while he or she is playing golf. Pr perhaps the packaging can be used for another golf-related purpose. Additionally, if the golf ball-shaped packaging was not make to the size of a golf ball, but was somewhat larger, the golf ball-shaped packaging could contain the golfer's car keys while he or she was playing golf.

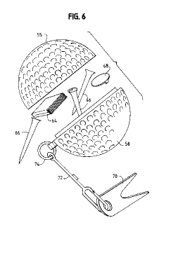

The packaging may, and preferably does have completely independent utility from that of the contents of the packaging. Such utility may include, by way of example, those of the outdoor items listed above, or that of a toy or a souvenir of the trip to Disneyland. Such utility may be enriched by securing a ring, tab, fixture, or other such structure to the packaging for attaching the packaging to another article. To illustrate, consider the golf ball-shaped packaging which was described above as having such a ring 74 for use with a clip 72 to join to a divot repair tool 70 or the like. See FIGURE 6 -- which also illustrates golf tees 66, rain gear 64, and disk 68.

In preferred embodiments of the invention, the thematically-shaped packaging is shaped as a golf ball, the item inside the packaging is rain gear, and the suggested use is in protecting a golfer from rain while playing golf. There can be an item or article having a use suggested by the shape of the packaging, as has been indicated elsewhere herein.

For marketing, a preferred embodiment is to locate the thematically-shaped packaging within other suggestive packaging-preferably suggestive by virtue of its shape too. Such suggestive packaging preferably can be configured as sleeve of golf balls.

Accordingly, the various embodiments of the present invention, as well as their applications and packaging, are considered illustrative and part of the teaching of the invention and how to make and use it. The scope of the invention is intended to be defined by the claims set forth below.

Claims

5.A method for making a combination of a thematic package and an article contained within the package, the method including the steps of:
constructing the package as a replica of a recognizable icon, the package
having a shape that is different than a shape of the article contained therein,
the shape of the package visually conveying information about an activity associated with the icon in which the article is used, and,
the package having a hollow interior; and
locating the article within the hollow interior of the package to form a combination of the article and the thematically-shaped package.

8.The method of claim 5, wherein the step of constructing includes: constructing a replica of a golf ball.

9.The method of claim 5, wherein the step of constructing includes: constructing a replica of a baseball.

10.The method of claim 5, wherein the step of constructing includes: constructing a replica of a life preserver.

11.The method of claim 5, wherein the step of constructing includes: constructing a replica of a football.

12.The method of claim 5, wherein the step of constructing includes: constructing a replica of a tennis ball.

13.The method of claim 5, wherein the step of constructing includes: constructing a replica of a soccer ball.

14.The method of claim 5, wherein the step of constructing includes: constructing a replica of a rugby ball.

15.The method of claim 5, wherein the step of constructing includes: constructing a card symbolizing charge and bank cards.

17.The method of claim 5, further including the step of locating a logo on the replica.

18.The method of claim 5, further including the step of: adding an outer layer of packaging also shaped to visually convey information about the associated activity.

19.The method of claim 18, wherein the outer layer includes a sleeve for golf balls.

20.The method of claim 5, wherein the step of constructing further includes the step of:
constructing the replica to have additional utility and having a shape visually conveying information about an activity associated with the replica.

21.The method of claim 19, wherein the step of constructing the replica to have additional utility includes the step of:
constructing a toy.

22.The method of claim 20, wherein the step of constructing the replica to have additional utility further includes the step of:
constructing the replica to receive subsequent writing from a pen or magic marker thereon.

23.The method of claim 5, further including a means for attaching the replica to an other article.

24.A method for making packaging, the method including the steps of:
providing an object in a package,
the package being shaped like a particular ball to visually convey information about a particular activity associated with said ball,
the object being a member of the group of rain gear consisting of a wiping cloth, a rain coat, a rain vest, a golf bag cover, a ditty bag, a poncho, a hat, and a seat cover
the member being useful during the activity wherein the package is openable to remove the object for use of the object while engaged in the associated activity.

25.A method for making thematically-shaped packaging for a thematically associated article contained therein, the method including the step of:
constructing a package having a shape that is a recognizable icon visually conveying information about an activity associated with the icon,
the package having a hollow interior to form the packaging for the article;
locating the article within the hollow interior of the package,
the article having a use in the associated activity to form a combination of the article and the thematically-shaped packaging; and wherein the step of constructing further includes the step of:
constructing the package as a replica of a golf ball to visually convey information of association of the activity of a game of golf; and wherein the step of locating the article within the packaging further includes the step of:
locating rain gear, as the article, within the hollow interior of the replica such that the rain gear is visually associated for use in the activity of playing the game of golf in the rain.

26.A method of making thematically-shaped packaging for an article contained therein, the method including the steps of:
constructing the package as a replica of a symbol having a shape that visually conveys information about an activity associated with the symbol,
the package having a hollow interior to form the packaging for the article;
locating the article within the hollow interior of the packaging,
the article having a use in the associated activity
and forming activity and forming a combination of the article and the thematically-shaped packaging;
and wherein the step of constructing further includes the step of:
constructing the package as a replica of a baseball to visually convey information about the associated activity of a baseball game;
and wherein the step of locating the article within the package further includes the step of:
locating rain gear, as the article, within the packaging such that the rain gear is visually associated with the associated activity of watching the baseball game in the rain.

27.The method of any one claims 5 and 8-23, further including the step of:
packaging the package within an other package, the other package suggestive of the member of the group.

28.The method of any one of claims 5 and 8-23, wherein the step of locating the article within the hollow includes engaging lips on respective portions of the package to encase the article, the portions forming halves of the hollow when joined during the locating step.

29.The method of any one claims 5 and 8-23, wherein the step of constructing includes constructing out of plastic.

30.The method of claim 29, wherein the step of locating is carried out with the article being an article made of plastic.

31.The method of claim 26, wherein the step of locating the article within the hollow includes engaging lips on respective portions of the ball to encase the article.
